(19) United States
(12) Patent Application Publication
(10) Pub. No.: US 2026/0001285 A1
(43) Pub. Date: Jan. 1, 2026

(54) SHAPE-MEMORY ARTICLES AND METHOD OF MANUFACTURE

(71) Applicant: Baker Hughes Oilfield Operations LLC, Houston, TX (US)

(72) Inventor: Ping Duan, Cypress, TX (US)

(21) Appl. No.: 19/057,481

(22) Filed: Feb. 19, 2025

Related U.S. Application Data
(60) Provisional application No. 63/664,349, filed on Jun. 26, 2024.

(51) Int. Cl. B29C 67/20; B29C 61/06; B29K 71/00; B29K 81/00; B29K 105/04; B29L 31/26; E21B 43/08

(52) U.S. Cl. CPC B29C 67/202; B29C 61/0608; E21B 43/082; B29K 2071/00; B29K 2081/00; B29K 2105/04; B29L 2031/265

(57) ABSTRACT

A method of manufacturing a shape-memory article includes combining a polymer with a particulate water soluble salt to form a mixture; molding the mixture to form a molded article; heating the molded article in the presence of oxygen, forming a sintered article comprising a crosslinked polymer; exposing the sintered article to water to remove the particulate water soluble salt from the sintered article, forming the shape-memory article, which is a porous foam comprising the crosslinked polymer.

### CROSS REFERENCE TO RELATED APPLICATIONS

This application claims the benefit of an earlier filing date from U.S. Provisional Application Ser. No. 63/664,349 filed Jun. 26, 2024, the entire disclosure of which is incorporated herein by reference.

### BACKGROUND

Shape-memory polymers (SMPs) are polymers that regain their original shape when heated above their glass transition temperature (Tg). Articles are formed from shape-memory polymers by first heating above the glass transition temperature and shaping the polymer, then subsequently fixing the shape by cooling to below the glass transition temperature. During deployment, the shaped articles are heated above the glass transition temperature or slightly below the glass transition temperature to allow recovery of the first molded shape. In addition to temperature change, the shape-memory effect can also be triggered by an electric or magnetic field, light, contact with a particular fluid or a change in pH.

Shape-memory polymers can be used to make porous foams for sand control applications. To produce a porous foam, shape-memory polymers are molded together with a blowing agent (also known as a foaming agent), which can include a chemical blowing agent such as a carbonate; bicarbonate; nitrite; and azodicarbonamide, or a physical blowing agent such as an inorganic physical blowing agent containing nitrogen, carbon dioxide, water or air; or an organic physical blowing agent. Alternative methods of making shape-memory porous foams, particularly foams with improved chemical resistance and good physical properties at high temperature conditions experienced downhole are continuously sought.

### SUMMARY

A method of manufacturing a shape-memory article includes combining thermoplastic polymeric powders with a particulate water soluble salt to form mixed powders; molding the mixed powders to form a molded article; heating the molded article in the presence of oxygen or air, forming a sintered article comprising a crosslinked polymer; exposing the sintered article to water to remove the particulate water soluble salt from the sintered article, forming the shape-memory article, which is a porous foam comprising the crosslinked polymer.

A downhole assembly includes a support structure; a shape-memory article disposed at the support structure; and the shape-memory article comprising a porous foam, the porous foam comprising at least one of an amorphous crosslinked polyetheretherketon, an amorphous crosslinked polyetherketoneketone, an amorphous crosslinked polyphenylene sulfide, or an amorphous crosslinked polyphenylsulfone.

A method includes introducing into a wellbore a downhole assembly having a support structure; a shape-memory article disposed at the support structure and comprising a porous foam, which contains at least one of an amorphous crosslinked polyetheretherketon, an amorphous crosslinked polyetherketoneketone, an amorphous crosslinked polyphenylene sulfide, or an amorphous crosslinked polyphenylsulfone, and wherein the downhole assembly is disposed when the shape-memory article is in a compacted shape; and contacting the shape-memory article in the compacted shape with a fluid to cause the shape-memory article to expand, and conform to a surface of the wellbore.

### BRIEF DESCRIPTION OF THE DRAWINGS

The following descriptions should not be considered limiting in any way. With reference to the accompanying drawings, like elements are numbered alike:

FIG. 1 illustrates a downhole assembly;

FIG. 2 illustrates the downhole assembly of FIG. 1 after deployment.

FIG. 3 is a graph of heat flow (W/g) versus temperature (° C.) of an un-crosslinked polyetheretherketon (PEEK) powder and a crosslinked PEEK foam;

FIG. 4 is a graph of storage modulus G′ (dyne/cm²) as a function of temperature (° C.) for an injection molded PEEK part made by a commercial method and a crosslinked PEEK foam made by a method as disclosed herein;

FIG. 5 is a graph of storage modulus G′ (dyne/cm²) as a function of temperature (° C.) for PEEK foams sintered at 760° F. for 1 to 5 hours;

FIG. 6 is a graph of storage modulus G′ (dyne/cm²) as a function of temperature (° C.) for a dry, crosslinked PEEK foam and a wet, crosslinked PEEK foam which is submerged in a water/oil mixture;

FIG. 7 is a graph of compressive stress (psi) versus compressive strain (%) for crosslinked PEEK foams having different densities;

FIG. 8 is a graph showing the aging results of crosslinked PEEK foams aged in 3% KCl;

FIG. 9 is a graph of compressive stress (psi) versus compressive strain (%) for an un-aged, crosslinked PEEK foam and crosslinked PEEK foams which have been aged in a crude oil at 325° F.; and

FIG. 10A shows a crosslinked PEEK article after aging in a crude oil at 325° F. for 90 days, and FIG. 10B shows the crosslinked PEEK article of FIG. 10A after a compression test.

### DETAILED DESCRIPTION

A detailed description of the disclosed method and downhole assembly are presented herein by way of exemplification and not limitation with reference to the Figures.

A shape-memory article and a method for making and using the shape-memory article are described herein. The shape memory article is a porous foam and can be manufactured without using any blowing agents. The porous foam comprises a crosslinked polymer, and has excellent porosity, good chemical resistance at high temperatures, and a balance of desired expansion and physical properties.

The article can be made from thermoplastic polymeric powders and a particulate water soluble salt. The polymer can have a glass translation temperature of about 120° C. to about 200° C. Examples of the polymer include a polyetheretherketon (PEEK), a polyetherketoneketone, a polyphenylene sulfide, and a polyphenylsulfone. The polymer can be at least partially crystalline or crystalline. For example, the polymer is a linear crystalline polymer. PEEK is preferred. The polymer can be in in a particulate form. The particle size of the polymer can be about 30 microns to about 120 microns, about 50 microns to about 140 microns, or about 70 microns to about 160 microns.

The particulate water soluble salt has a melting point of greater than 300° C. or greater than 400° C., for example about 400° C. to about 900° C., about 400° C. to about 800° C., or about 500° C. to about 800° C. The particulate water soluble salt can also have a solubility in water of greater than 25 grams per 100 grams of water at 25° C., for example about 30 grams to about 100 grams per 100 grams of water at 25° C. Examples of the particulate water soluble salt are sodium chloride, calcium chloride, and magnesium chloride. Other water soluble salts that have the melting points and solubility in water as described herein can also be used.

The particle size of the water soluble salt affects the cell size of the porous foam. The particulate water soluble salt can have a particle size of about 0.062 millimeter (mm) to about 1 mm, about 0.062 mm to about 0.088 mm, about 0.125 mm to about 0.250 mm, or about 0.50 mm to about 1.00 mm. The particle size can be determined by stacked sieves on mechanical shaker.

The weight ratio of the polymer and the particulate water soluble salt affect the porosity and density of the manufactured porous foam. The polymer and the particulate water soluble salt can have a weight ratio of about 10:90 to about 90:10, about 20:80 to about 80:20, or about 30:70 to about 70:30. Preferably, the polymer and the particulate water soluble salt can also have a weight ratio of about 10:90 to about 50:50, about 10:90 to about 40:60, or about 10:90 to about 30:70.

The method to combine or mix the polymer and the particulate water soluble salt is not particularly limited. For a large scale manufacturing process, powder blends can be used to combine, mix, and/or blend the polymer and the particulate water soluble salt. Examples of commercial powder blenders include double cone blender which is available from companies such as Charles Ross & Son Company with model number DCB-5.

The mixture of the thermoplastic polymeric powders and the particulate water soluble salt (sometimes referred to herein as “the mixed powders”) can be uniform. In addition, the mixture can be free of blowing agents, crosslinking agents, curing agents, or a combination thereof. The blowing agents, crosslinking agents, and curing agents include those known in the art.

The mixed powders can then be added to a mold, where the mixed powders are pressed at a pressure of about 1000 psi to about 1900 psi, about 1000 psi to about 1500 psi, about 1200 psi to about 1700 psi, or about 1400 psi to about 1900 psi to form a compressed molded article. The mixed powders can be molded at room temperature, for example 15° C. to 30° C. for about 1 minute to about 5 minutes, about 1 minute to about 2 minutes, or about 2 minutes to about 3 minutes. The mold has a bottom plate and a center ring and a center piston. Other molds known in the art can also be used. The molded article can have a density of about 1.37 g/cm³ to about 1.45 g/cm³, or about 1.45 g/cm³ to about 1.52 g/cm³. The compressed molded article may be formed during compression into any geometric shape including for example a tubular shape, a cylinder shape, etc. The molded article is of sufficient strength that it can be removed from the mold without damage or change of its shape. In embodiments, water may be added in amounts from, for example, about 1 percent to about 5 percent by weight of total combined weight of the thermoplastic polymeric powder and salt. The added water increases weight of the salt particles and enhances strength of the molded part. In embodiments, water is added to the salt, with mixing, to create a homogenous mixture of water and salt prior to mixing with the thermoplastic polymer powder.

The molded article can be heated at a temperature that is greater than the melting temperature of the polymer but lower than the melting temperature of the particulate water soluble salt. If the polymer melts over a temperature range, and range is bound at the low end by the solidus temperature, and at the high end by the liquidus temperature, then the melting temperature of the polymer refers to the liquidus temperature of the polymer. The molded article can be heated at a temperature of about 300° C. to about 800° C., about 300° C. to about 600° C., or about 300° C. to about 500° C., or about 300° C. to about 400° C.

During heating, the water soluble salt does not melt, and the thermoplastic polymeric powder melts, the polymer are bonded together around the salt particles. The molded article is heated in the presence of oxygen, which can be a pure oxygen or air. The heating, which is conducted at a temperature that is above the melting point of the polymer in the presence of oxygen, converts the polymer from a linear crystalline thermoplastics to a crosslinked amorphous polymer. Contrary to the original linear crystalline thermoplastic polymer which flows at the temperature above its melting point, the crosslinked amorphous polymer exhibits rubbery-like elastomeric property at a wide temperature ranging above its glass transition temperature. Thus, the sintered article comprises a crosslinked polymer, preferably an amorphous crosslinked polyetheretherketon, an amorphous crosslinked polyetherketoneketone, an amorphous crosslinked polyphenylene sulfide, or an amorphous crosslinked polyphenylsulfone.

The heating can be conducted at atmospheric pressure for about 1 hour to about 10 hours, or about 2 hours to about 8 hours, or about 3 hours to about 5 hours.

After sintering, optionally the article is cooled down, for example, to an ambient temperature. The sintered article can be exposed to water to remove the particulate water soluble salt from the sintered article, forming the shape-memory article, which is a porous foam comprising the crosslinked polymer. For efficiency, the sintered article can be exposed to water having a temperature of about 60° C. to about 100° C., about 80° C. to about 100° C., or exposed to boiling water to remove the particulate water soluble salt from the molded article.

After the water soluble salt is removed from the sintered article, the article can be optionally dried to remove water, forming the shape-memory article.

The shape-memory article can have a density of about 0.19 g/cm³ to about 0.37 g/cm³, about 0.19 g/cm³ to about 0.27 g/cm³, or about 0.27 g/cm³ to about 0.37 g/cm³.

The shape-memory article can have a porosity of about 30 darcy to about 100 darcy, about 30 darcy to about 50 darcy, about 50 darcy to about 70 darcy, or about 70 darcy to about 100 darcy when tested with water. For filtering such as sand control applications, the shape-memory article can be an open cell foam or a foam having both open and closed cells. It is preferred to have open cell greater than or equal to about 71% by volume (e.g. about 71% to about 90% by volume) and less than 1% close cell by volume. The percentage of open cell and close cell can be determined by use of a densimeter.

The shape-memory article can also have excellent chemical resistance at high temperatures. The porous foam can be stable in a brine (e.g. KCl brine) and oil at elevated temperatures (e.g. up to 180° C.) for several months or years.

The shape-memory article can be installed in a downhole assembly. The downhole assembly includes a support structure; and a shape-memory article disposed at the support structure. As used herein, “disposed at” means that the shape-memory article can surround the support structure, partially surround the support structure, or couple to the support structure without surrounding or partially surrounding the support structure. For example, the shape-memory article can be coupled to the end of the support structure. The support structure can be a tubular member having a fluid conduit defined therein, for example, a pipe (e.g. perforated base pipe), tubing, or string. As an example, the support structure can be a base pipe having a portion that is perforated or slotted, and the shape-memory article is disposed at or at least partially surrounds the perforated or slotted portion of the base pipe.

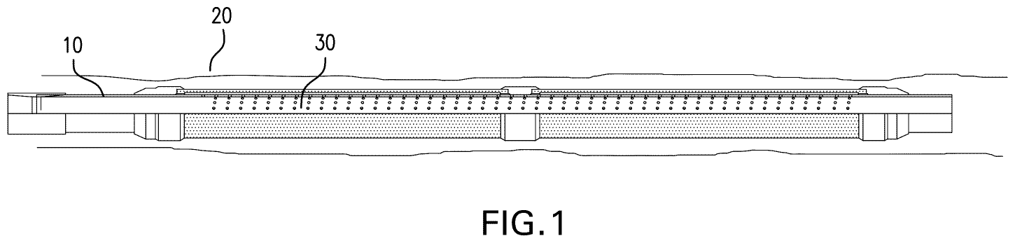

Referring to FIG. 1, a shape-memory article (30) can be disposed on a support structure (10) such as a pipe (e.g. perforated base pipe), tubing, or string to form a downhole device. Before deployment, the shape-memory article is in a deformed state or a compacted shape. Deformed shape-memory article can be made by compressing or stretching the article with a mechanical force at a temperature greater than the glass transition temperature of the crosslinked polymer. While still in the deformed state, the article is cooled down to a temperature below the glass transition temperature of the crosslinked polymer. The shape-memory article remains in the deformed shape induced on it after manufacture at surface temperature or at wellbore temperature during run-in.

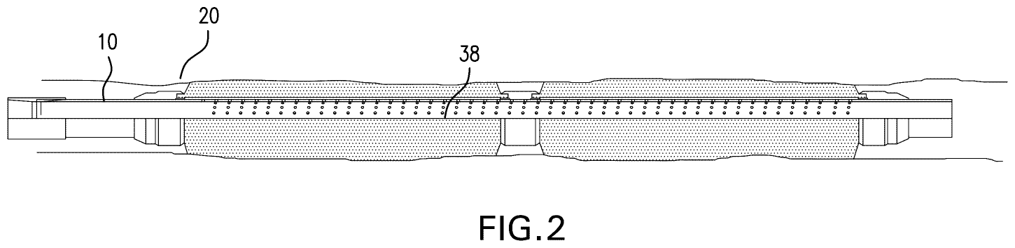

Once the downhole assembly is placed at the desired location, the shape-memory article can expand and conform to a surface (20) of the wellbore due to the temperature increase, and/or exposure to an activation fluid, providing an expanded shape-memory article (38) as shown in FIG. 2.

The activation fluid can contain an activator. Examples of the activator can include dimethyl sulfoxide, ketones, alcohols, phenols, ethers, esters, or acids. More than one activator can be used. As used herein, an alcohol refers to an organic compound having one or more hydroxyl groups attached to a saturated carbon atom. Examples of the alcohols include methanol, ethanol, isopropyl alcohol, n-butanol, 2-butanol, isobutanol, tert-butanol, n-pentanol, isopentanol, 2-pentanol, hexanol, octanol, isooctanol, cyclohexanol, 2-methyl-1-butanol, 2-methyl-1-pentanol, 3-methyl-2-butanol, 2-ethylhexanol, or glycols. The alcohol can be substituted and include ethoxylated alcohols, propoxylated alcohols, ethoxylated or propoxylated alcohols, or 2-butoxyethanol. The ethoxylated and/or propoxylated alcohols can have a structure represented by the Formula R—(OCH₂CH₂)ₘ(OCH₂CH₂CH₂)ₙ—OH, wherein R is a C₁₋₇ alkyl, C₁₋₅ alkyl, C₁₋₃ alkyl, or ethyl, m is 0 to 8, and n is 0 to 8, provided that the sum of m and n is at least 1.

Examples of glycols include ethylene glycol, propylene glycol, 1,3-propanediol, 1,4-butanediol, 1,2,4-butanetriol, glycerin, erythritol, ethoxylated glycols, propoxylated glycols, ethoxylated or propoxylated glycols, diethylene glycol, or butoxy tri-glycol. Phenols can be substituted and include ethoxylated phenols, propoxylated phenols, or ethoxylated or propoxylated phenols.

Examples of esters include n-butyl acetate, n-butyl propionate, n-propyl propionate, n-pentyl propionate, or ethylene glycol monoethyl ether acetate. Exemplary ethers include ethylene glycol monobutyl ether (EGMBE). Specific ketones include acetone and acetylacetone. Examples of acids include adipate or maleate.

For an activator that is normally a liquid at room temperature, a modifying agent can be used to covert the liquid activator to a solid, hydrogel, or xerogel (modified activator). The activator can be controllably released from the powder, hydrogel, or xerogel by dissolving or corroding the modifying agent in water or brine.

As a result of the shape-memory article being expanded to its set position, the open cell porous shape-memory article can prevent production of undesirable solids and allow only desired hydrocarbon fluids to flow through the shape-memory foam. The foam cell pore size, size distribution and cell openness may be adjusted by varying the weight ratio between the polymer and the particulate water soluble salt, and/or varying the sizes of the particulate water soluble salt and the polymer in such a way that only desired hydrocarbon fluids are allowed to flow through and undesirable solids (sands, formation fines/particles, etc.) in the wellbore are prevented from being produced.

The shape-memory articles are further illustrated by the following non-limiting examples.

### EXAMPLES

Crosslinked PEEK samples/foams were prepared as follows. Water soluble salt particles (NaCl) were mixed with a PEEK powder (un-crosslinked). The mixture was compacted in a mold, then sintered at a temperature of about 700° F. unless indicated otherwise for about 5 hours at atmospheric pressure. The sintered product was immersed in boiling water for hours to make sure that salts were removed from the sintered product by dissolving in water.

The product was dried, and trimmed to the desired shape if needed for further testing.

### Thermal Properties by Differential Scanning Calorimetry (DSC)

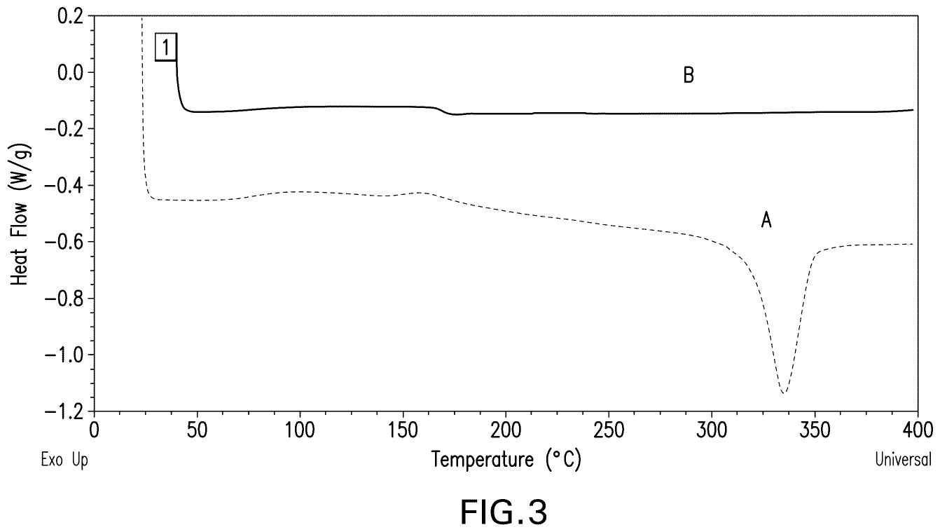

The heat flow of an un-crosslinked PPEK powder (A) at various temperatures was compared with the heat flow of a crosslinked PEEK foam (B), and the results are summarized in FIG. 3.

FIG. 3 shows that PEEK powder comprises a crystalline polymer with a melting temperature of 335.36° C. In contrast, the crosslinked PEEK foam comprises an amorphous polymer, without any melting point.

### Thermomechanical Properties (Storage Modulus) by Dynamic Mechanical Analyzer (DMA)

Storage modulus is a measure of how much energy must be put into a sample in order to distort it.

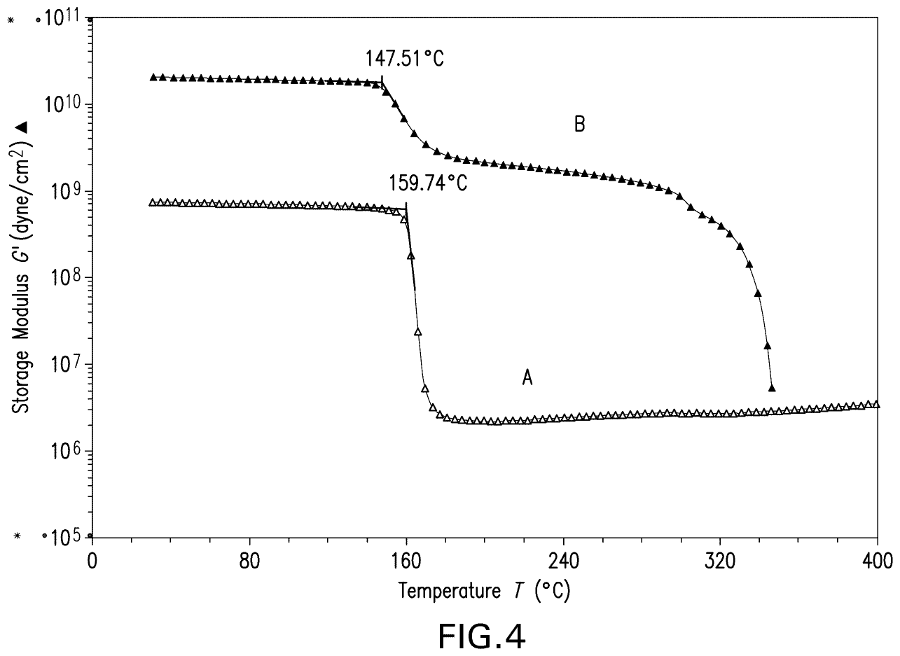

The storage modulus of a crosslinked PEEK foam (A), made by a method as described herein, is compared with the storage modulus of an injection molded PEEK part made by a commercial method (B). The results are summarized in FIG. 4.

FIG. 4 shows that the crosslinked PEEK foam made by a method as disclosed herein maintains storage modulus and exhibits rubbery plateau at a wide temperature range above its glass transition temperature (159.74° C.). This means that the crosslinked PEEK foam can maintain its elasticity at a wide downhole temperature range (up to 400° C.).

In contrast, the injection molded PEEK part made by a commercial method does not maintain its modulus at a relatively high temperature. When the part is exposed to a temperature that is above its glass transition temperature (147.51° C.), it loses the modulus exhibiting a liquid flow behavior, which means that the PEEK part is not suitable for high temperature downhole applications.

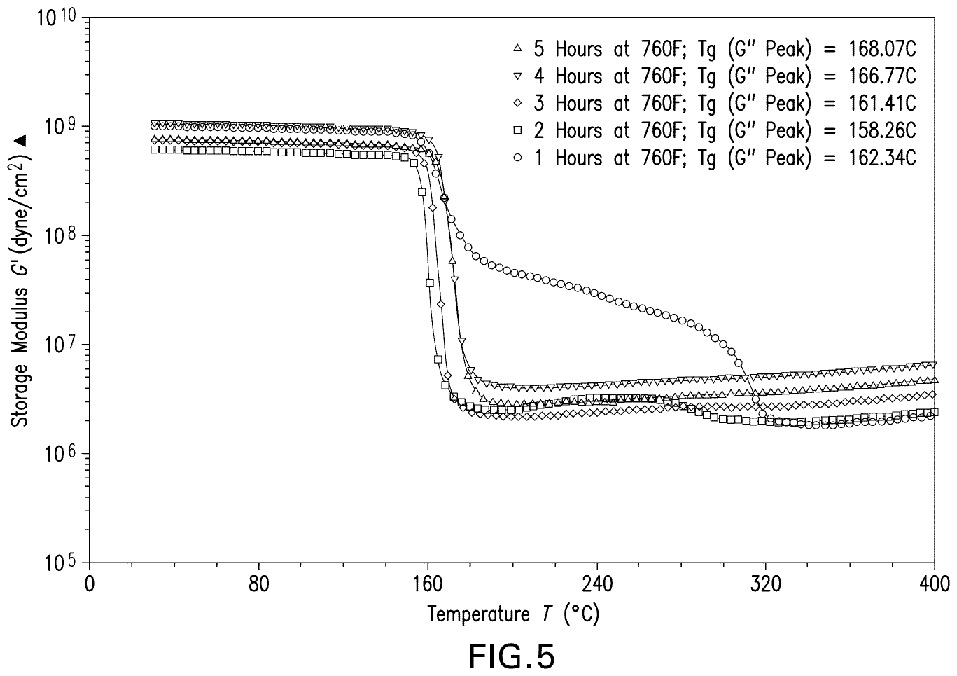

The effects of sintering time on storage modulus were evaluated, and the results are summarized in FIG. 5. FIG. 5 shows that as sintering time increases, storage modulus increases, indicating that the degree of crosslinking of PEEK increases. The results also show that sintering at 760° F. for 3-5 can provide parts with the desired storage modulus.

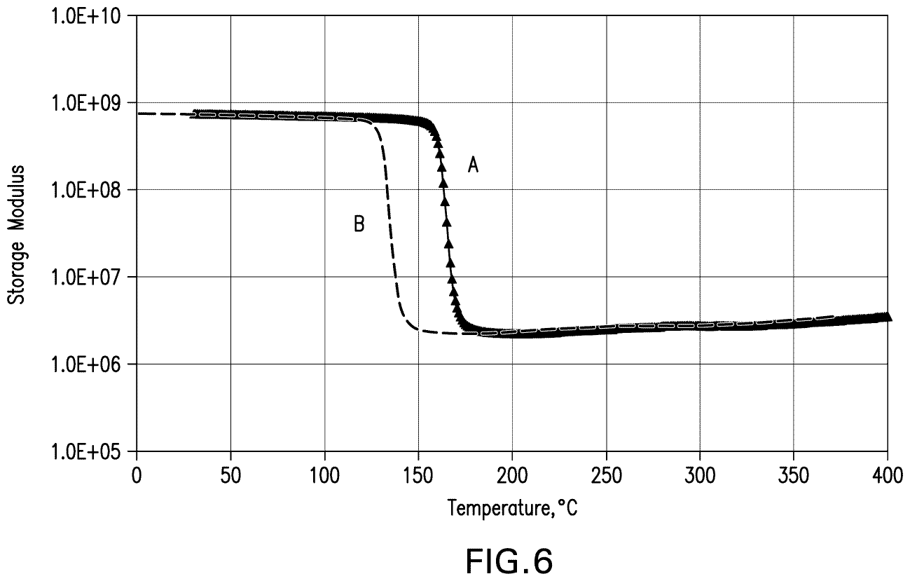

Since downhole tools are often exposed to various fluids, the storage modulus of a dry, crosslinked PEEK foam (A) is compared with the storage modulus of a wet, crosslinked PEEK foam (B) which is submerged in a water/oil mixture. The results are summarized in FIG. 6.

FIG. 6 shows that upon submersion, the glass transition temperature (Tg) of the foam shifts to a lower temperature. The Tg can shift more in oil than in water. The storage modulus remains the same above the foam's Tg.

### Compressive Mechanical Properties

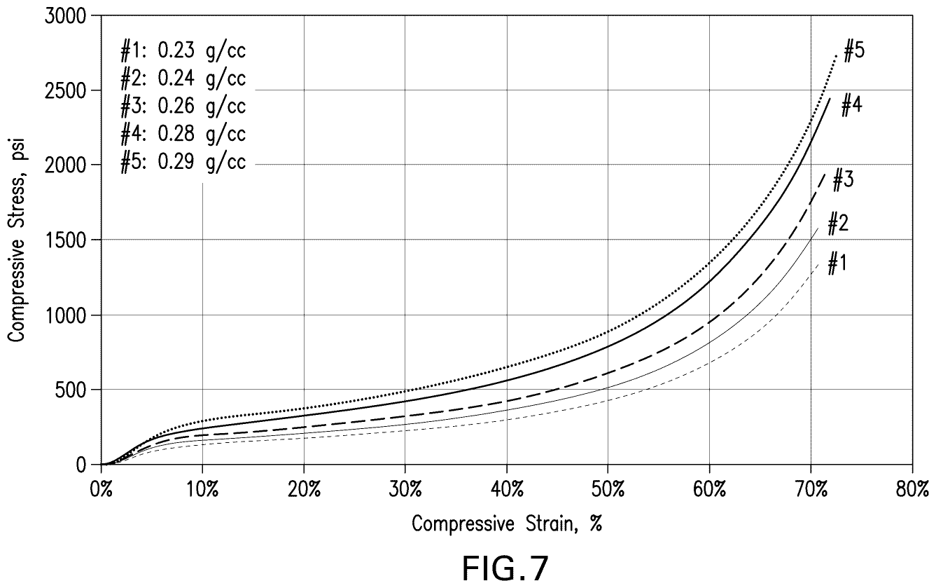

The compressive mechanical properties of the crosslinked PEEK foams were studied. No cracks were observed during the testing, and the foams maintained good integrity. The stress-stain curves of various foams with different densities are summarized in FIG. 7 and Table 1. The results show that compression curves progress uniformly, which means that the foams are tough (not brittle).

TABLE 1

| | Density | Stress at 25% | Stress at 50% |
|---|---|---|---|
| Sample | (g/cc) | Strain (psi) | strain (psi) |
| 1-1 | 0.23 | 199 | 441 |
| 1-2 | 0.24 | 239 | 518 |
| 1-3 | 0.26 | 282 | 611 |
| 1-4 | 0.28 | 268 | 795 |
| 1-5 | 0.29 | 439 | 893 |
| Average | 0.26 | 305 | 651 |

The unit “g/cc” means gram per cubic centimeter.

### Expansion Properties

The PEEK foam RIH (run-in-hole) expansion results are shown in Table 2. The results indicate that the crosslinked PEEK foam can have limited expansion when contacted with a RIH fluid for 24 hours at a temperature of up to 260° F.

TABLE 2

| | RIH | Oil/ | | | |
|---|---|---|---|---|---|
| | fluid | Water | Temp. | Time | % |
| Sample | (ppg) | ratio | (° F.) | (hours) | Expansion |
| 2-1 | 9 | 90:10 | 250 | 24 | 1.7% |
| 2-2 | 12 | 90:10 | 250 | 24 | 3.7% |
| 2-3 | 14 | 80:20 | 250 | 24 | 1.0% |
| 2-4 | 9 | 90:10 | 260 | 24 | 4.7% |
| 2-5 | 12 | 90:10 | 260 | 24 | 1.8% |
| 2-6 | 14 | 80:20 | 260 | 24 | 2.5% |
| 2-7 | 9 | 90:10 | 270 | 24 | 55.5% |
| 2-8 | 12 | 90:10 | 270 | 24 | 22.6% |

The RIH fluid is DELTA-ETQ available from Baker Hughes.
The term “ppg” means pounds per gallon.
Temp. refers to temperature.

The sintered and crosslinked PEEK foam deployment test results are shown in Table 3. The results show that the crosslinked PEEK foam can be deployed with various activation fluids at various temperatures.

TABLE 3

| | | Oil/ | | % | % |
|---|---|---|---|---|---|
| | Deployment | Water | Temp. | Expansion | Expansion |
| Sample | fluid | ratio | (° F.) | Day 1 | Day 2 |
| 3-1 | EGMBE | 100:0 | 200 | 62% | 186% |
| 3-2 | DE Acetate | 100:0 | 200 | 172% | 169% |
| 3-3 | 10% EGMBE | 10:90 | 200 | 8.0% | 12.5% |
| 3-4 | 10% DE acetate | 10:90 | 200 | 3.6% | 3.8% |
| 3-5 | 10% EGMBE | 10:90 | 220 | 124% | 206% |
| 3-6 | 5% EGMBE | 0:100 | 230 | 24% | 97% |
| | GEOWASH | | | | |
| 3-7 | GEOWASH | 0:100 | 240 | 24% | 212% |
| 3-8 | GEOWASH | 0:100 | 250 | 24% | 295% |

EGMBE means ethylene glycol monobutyl ether.
DE acetate means diethylene glycol monoethyl acetate
GEOWASH is a commercial product available from BAKER HUGHES.

### Foam Porosity and Permeability

The porosity of the crosslinked PEEK foams was evaluated, and the results are shown in Table 4. The results indicate that the crosslinked PEEK foams with various densities have good open cell porosity, and won't block the flow of fluids. Compared to the crosslinked PEEK foams shown in Table 4 with a density of 0.19-0.37 g/cc, solid PEEK powder has a density of 1.32 g/cc.

TABLE 4

| | | | | Porosity by | Porosity by | |
|---|---|---|---|---|---|---|
| | | | | Densimeter | Calculation | |
| | Salts | PEEK | Density | (Open Cells | (Open + Closed | Closed |
| Sample | g | g | g/cc | only) | Cells) | Cells |
| 4-1 | 60 | 20 | 0.37 | 71.4% | 72.2% | 0.8% |
| 4-2 | 62.5 | 17.5 | 0.30 | 77.0% | 77.7% | 0.7% |
| 4-3 | 65 | 15 | 0.26 | 80.0% | 80.6% | 0.6% |
| 4-4 | 67.5 | 12.5 | 0.23 | 82.3% | 82.9% | 0.6% |
| 4-5 | 70 | 10 | 0.19 | 85.0% | 85.4% | 0.5% |

The permeability of crosslinked PEEK foams with different densities were evaluated, and the results are shown in Table 5. The results shown that the crosslinked PEEK foam prepared via a method as disclosed herein have good permeability, and the permeability does not depend on the density of the foams.

TABLE 5

| | Composition | | |
|---|---|---|---|
| | (salt:PEEK) | Density | Permeability |
| Sample | g | g/cm | Darcy |
| 5-1 | 60:20 | 0.35 | 60-80 |
| 5-2 | 62.5:17.5 | 0.31 | 80-100 |
| 5-3 | 65:15 | 0.28 | 50-70 |
| 5-4 | 67.5:12.5 | 0.22 | 60-80 |
| 5-5 | 70:10 | 0.18 | 80-100 |

The permeability of crosslinked PEEK foams with different cell sizes were evaluated, and the results are shown in Table 6. The cell size is controlled by the particle size of the water soluble salt. The results shown that the crosslinked PEEK foams with different cell sizes have good permeability, and the permeability does not depend on the cell size of the foams.

TABLE 6

| | Salt | | |
|---|---|---|---|
| | Category (weight | dP | Permeability |
| Sample | average particle size) | psi | Darcy |
| 6-1 | Coarse (1.82 mm) | 0.035 | 100 |
| 6-2 | Coarse (1.82 mm) | 0.03 | 150-200 |
| 6-3 | Medium (0.55 mm) | 0.015 | 200-250 |
| 6-4 | Medium (0.55 mm) | 0.015 | 200-250 |
| 6-5 | Intermediate (1.22 mm) | 0.025 | 150-180 |
| 6-6 | Intermediate (1.22 mm) | 0.02 | 150-200 |

dP means the pressure difference.

### Dynamic Load Tests

The dynamic load test results for crosslinked PEEK foams at 200° F. in water are shown in Table 7. The results show that at a load of up 400 psi in water, the crosslinked PEEK foams can have useful compaction and permeability properties.

TABLE 7

| | Compaction (%) | | | Permeability (Darcy) | | |
|---|---|---|---|---|---|---|
| Load | Sample | Sample | Sample | Sample | Sample | Sample |
| (psi) | 7-1 | 7-2 | 7-3 | 7-1 | 7-2 | 7-3 |
| 100 | 97.9 | 94 | 90.2 | 30 | 33 | 50-100 |
| 200 | 96.5 | 91 | 68 | 23 | 28 | 35 |
| 400 | 82.5 | 81 | 45.4 | 13 | 23 | 24 |
| 600 | 64.9 | 47 | 37.4 | 6 | 11.4 | 11 |
| 800 | 56 | 33 | 32.8 | 3 | 5.5 | 4.5 |
| 1000 | 50.5 | 26 | 28.4 | 1.2 | 2.6 | 2.8 |

*Sample 7-1 was prepared from 60 grams of salt particles and 20 grams of a PEEK powder. The foam has a density of 0.36 g/cm³.
**Sample 7-2 was prepared from 65 grams of salt particles and 15 grams of a PEEK powder. The foam has a density of 0.26 g/cm³.
*** Sample 7-1 was prepared from 67.5 grams of salt particles and 12.5 grams of a PEEK powder. The foam has a density of 0.23 g/cm³.

The dynamic load test results for PEEK foams at 250° F. in IBF oil are shown in Table 8. The results show that at a load of up 1000 psi in an oil, the crosslinked PEEK foams can have useful compaction and permeability properties. The results also show that the permeability can vary depending on the load.

TABLE 8

| | | |
|---|---|---|
| Compaction | Permeability | |
| (%) | (Darcy) | Load |

| | |
|---|---|
| Salt (g):PEEK (g) 65:15 Density 0.24 g/cm³ | (psi) |

| | | |
|---|---|---|
| 90.4 | 285 | 100 |
| 65.6 | 160 | 200 |
| 46.5 | 78 | 400 |
| 39.5 | 53 | 600 |
| 34.9 | 33 | 800 |
| 32 | 30 | 1000 |

### Sand Filtration

The sand filtration property of the fully deployed crosslinked PEEK foams at 200° F. in water are shown in Table 9. A small effluent % indicates good sand filtration property. The results show that the crosslinked PEEK foams of the disclosure have good sand filtration property in water at an elevated temperature.

TABLE 9

| | Density | | | | Sand |
|---|---|---|---|---|---|
| | (g/cm³) | Salt | Ambient | | inside |
| | Salt:PEEK | type/ | permeability | Effluent | Foam |
| Sample | (g) | size | (Darcy) | (%) | (%) |
| 9-1 | 0.26 | HEB | 65 | 0.1 | 3.4 |
| | 65:15 | | | | |
| 9-2 | 0.24 | Morton | 100-120 | 0.1 | 5.67 |
| | 65:15 | medium/0.55 mm | | | |
| 9-3 | 0.24 | Morton | 60-80 | 0.23 | 9.17 |
| | 65:15 | coarse/1.82 mm | | | |
| 9-4 | 0.24 | Mediterranean | 80-100 | 2.03 | 7.76 |
| | 65:15 | coarse/1.22 mm | | | |

The sand filtration properties of crosslinked PEEK foams expanded to gauge hole size were evaluated, and the results are shown in Table 10.

TABLE 10

| | Density | | | | Sand |
|---|---|---|---|---|---|
| | (g/cc) | Salt | Ambient | | inside |
| | Salt:PEEK | type/ | permeability | Effluent | Foam |
| Sample | (g) | size | (darcy) | (%) | (%) |
| 10-1 | 0.26 | HEB | 65 | 0.1 | 3.4 |
| | 65:15 | | | | |
| 10-2 | 0.17 | HEB | 120 | 0.25 | 1.36 |
| | 70:10 | | | | |
| 10-3 | 0.24 | Morton | 100-120 | 0.1 | 5.67 |
| | 65:15 | medium/0.55 mm | | | |
| 10-4 | 0.24 | Morton | 60-80 | 0.23 | 9.17 |
| | 65:15 | coarse/1.82 mm | | | |
| 10-5 | 0.26 | Mediterranean | 150-200 | 0.5 | 16.3 |
| | 65:15 | coarse/1.22 mm | | | |
| 10-6 | 65:15 | Mediterranean | 80-100 | 2.03 | 7.76 |
| | | coarse/1.22 mm | | | |

### Aging Tests

The stability of the crosslinked PEEK foams in NORSOK fluid was evaluated, and the results are summarized in Tables 11 and 12. No significant decrease of mechanical properties was observed after the crosslinked PEEK foams were immersed in NORSOK at a temperature of up to 325° F. for up to 90 days.

TABLE 11

| | Average/ | Compressive Stress at 20% Strain (psi) | | | | | |
|---|---|---|---|---|---|---|---|
| Conditions | Stdev | Un-aged | 3 days | 10 days | 30 days | 60 days | 90 days |
| NORSOK | Ave | 206 | 331 | 271 | 318 | 284 | 287 |
| fluid | | | | | | | |
| 275° F. | Stdev | 68 | 84 | 31 | 44 | 126 | 93 |
| NORSOK | Ave | 272 | 318 | 284 | 370 | 357 | 333 |
| fluid | | | | | | | |
| 300° F. | Stdev | 36 | 39 | 24 | 88 | 42 | 12 |
| NORSOK | Ave | 183 | 239 | 236 | 245 | 235 | 272 |
| fluid | | | | | | | |
| 325° F. | Stdev | 44 | 15 | 55 | 86 | 51 | 85 |

*Stdev means standard deviation.
* Ave means average.
*NORSOK means Norwegian Standards Organization.
*** NORSOK fluid was prepared by mixing 70% heptane, 20% cyclohexane and 10% toluene by weight.

TABLE 12

| | Average/ | Compressive Stress at 50% Strain (psi) | | | | | |
|---|---|---|---|---|---|---|---|
| Conditions | Stdev | Un-aged | 3 days | 10 days | 30 days | 60 days | 90 days |
| NORSOK | Ave | 437 | 600 | 503 | 589 | 485 | 497 |
| 275° F. | Stdev | 126 | 156 | 81 | 43 | 188 | 104 |
| NORSOK | Ave | 561 | 539 | 490 | 632 | 560 | 560 |
| 300° F. | Stdev | 71 | 40 | 53 | 169 | 42 | 20 |
| NORSOK | Ave | 402 | 464 | 518 | 491 | 437 | 561 |
| 325° F. | Stdev | 106 | 27 | 125 | 153 | 87 | 153 |

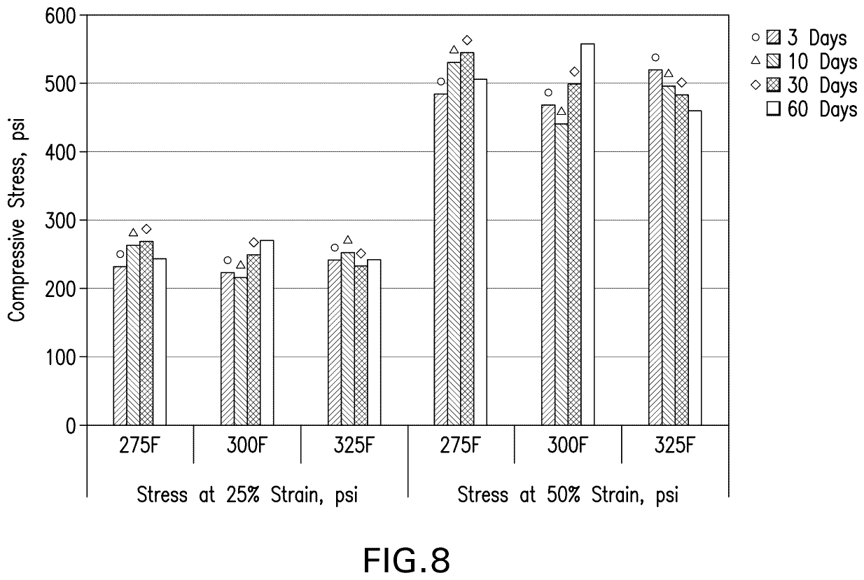

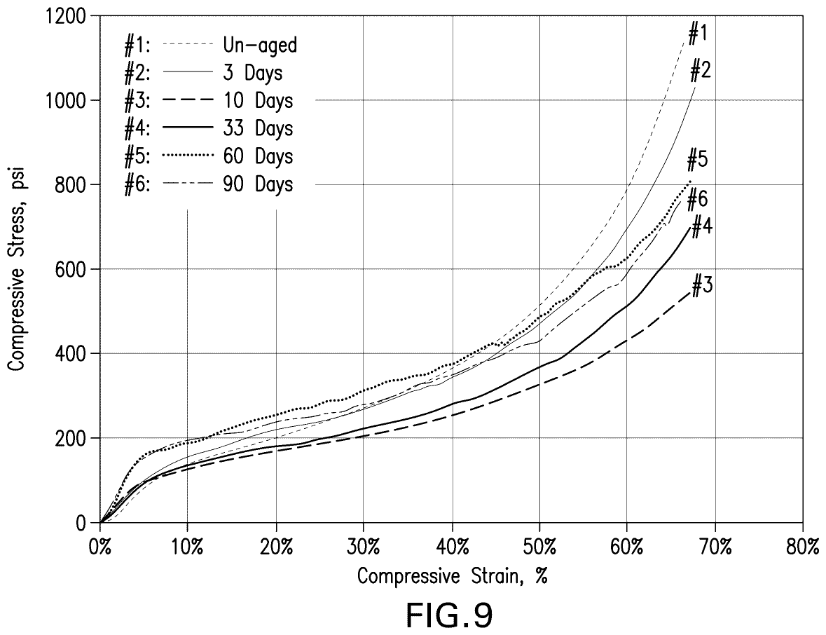

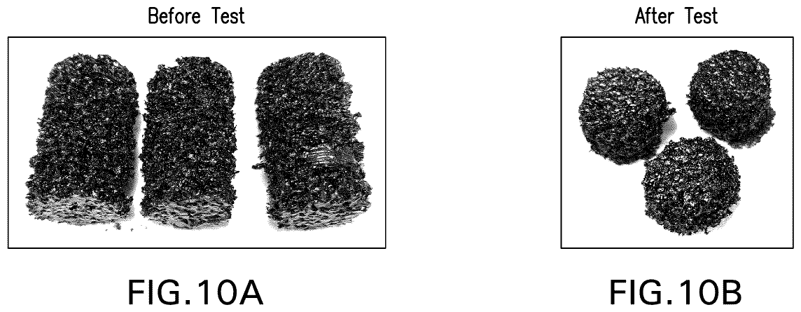

The stability of the crosslinked PEEK foams in a brine (3% KCl brine) or a crude oil was evaluated, and the results are summarized in FIGS. 8, 9, 10A and 10B. The results show that crosslinked PEEK foams are stable in 3% KCl brine and crude oil at elevated temperatures (up to 325° F.), and there was no sign of chemical degradation. In addition, the PEEK foams maintained good shape during the compression tests.

Set forth below are some methods/downhole assemblies of the foregoing disclosure:

Embodiment 1. A method of manufacturing a shape-memory article, the method comprising: combining a polymer with a particulate water soluble salt to form a mixture; molding the mixture to form a molded article; heating the molded article in the presence of oxygen, forming a sintered article comprising a crosslinked polymer; exposing the sintered article to water to remove the particulate water soluble salt from the sintered article, forming the shape-memory article, which is a porous foam comprising the crosslinked polymer.

Embodiment 2. The method as in any prior embodiment, wherein the polymer has a glass transition temperature of about 120° C. to about 200° C.

Embodiment 3. The method as in any prior embodiment, wherein the polymer is at least one of a polyetheretherketon, a polyetherketoneketone, a polyphenylene sulfide, or a polyphenylsulfone.

Embodiment 4. The method as in any prior embodiment, wherein the polymer is in a particulate form.

Embodiment 5. The method as in any prior embodiment, wherein the polymer and the particulate water soluble salt have a weight ratio of about 10:90 to about 90:10.

Embodiment 6. The method as in any prior embodiment, wherein the particulate water soluble salt has a particle size of about 0.062 millimeter to about 1 millimeter.

Embodiment 7. The method as in any prior embodiment, wherein the particulate water soluble salt has a melting point of greater than 300° C. and a solubility in water of greater than 25 grams per 100 grams of water at 25° C.

Embodiment 8. The method as in any prior embodiment, wherein the particulate water soluble salt comprises at least one of sodium chloride, calcium chloride, or magnesium chloride.

Embodiment 9. The method as in any prior embodiment, wherein the mixture is free of blowing agents, crosslinking agents, curing agents, or a combination thereof.

Embodiment 10. The method as in any prior embodiment, wherein the mixture is molded under a pressure of about 1000 psi to about 1900 psi to form the molded article.

Embodiment 11. The method as in any prior embodiment, wherein the mixture is molded at a temperature of about 15° C. to about 30° C.

Embodiment 12. The method as in any prior embodiment, wherein the molded article is heated at a temperature which is greater than a melting point of the polymer but less than a melting point of the particulate water soluble salt in the presence of oxygen to crosslink the polymer, forming the sintered article.

Embodiment 13. The method as in any prior embodiment, wherein the molded article is heated under atmospheric pressure to crosslink the polymer.

Embodiment 14. The method as in any prior embodiment, wherein the molded article is heated at a temperature of about 300° C. to about 800° C. under atmospheric pressure to crosslink the polymer, forming the sintered article.

Embodiment 15. The method as in any prior embodiment, wherein the sintered article is exposed to water having a temperature of about 60° C. to about 100° C. to remove the particulate water soluble salt from the molded article.

Embodiment 16. The method as in any prior embodiment, wherein the crosslinked polymer is amorphous.

Embodiment 17. The method as in any prior embodiment, comprising: combining the polymer with the particulate water soluble salt to form the mixture, the polymer comprising at least one of polyetheretherketon, a polyetherketoneketone, a polyphenylene sulfide, or a polyphenylsulfone, the particulate water soluble salt has a melting point of greater than 300° C. and a solubility in water of greater than 25 grams per 100 grams of water at 25° C.; molding the mixture at a temperature of about 15° C. to about 30° C. and a pressure of about 1000 psi to about 1900 psi to form the molded article; heating the molded article at a temperature that is greater than a melting point of the polymer but lower than a melting point of the particulate water soluble salt under atmospheric pressure in the presence of oxygen, forming the sintered article; and exposing the sintered article to water at a temperature of about 60° C. to about 100° C. to remove the particulate water soluble salt from the sintered article, forming the shape-memory article.

Embodiment 18. A downhole assembly comprising: a support structure; a shape-memory article disposed at the support structure; and the shape-memory article comprising a porous foam, the porous foam comprising at least one of an amorphous crosslinked polyetheretherketon, an amorphous crosslinked polyetherketoneketone, an amorphous crosslinked polyphenylene sulfide, or an amorphous crosslinked polyphenylsulfone.

Embodiment 19. The downhole assembly as in any prior embodiment, wherein the porous foam is free of blowing agents.

Embodiment 20. The downhole assembly as in any prior embodiment, wherein the porous foam comprises the amorphous crosslinked polyetheretherketon.

Embodiment 21. The downhole assembly as in any prior embodiment, wherein the amorphous crosslinked polyetheretherketon comprises polyetheretherketon crosslinked by oxygen.

Embodiment 22. The downhole assembly as in any prior embodiment, wherein the porous foam has a density of about 0.19 g/cm³ to about 0.37 g/cm³.

Embodiment 22. A method comprising: introducing into a wellbore a downhole assembly comprising a support structure; a shape-memory article disposed at the support structure and comprising a porous foam, which comprises at least one of an amorphous crosslinked polyetheretherketon, an amorphous crosslinked polyetherketoneketone, an amorphous crosslinked polyphenylene sulfide, or an amorphous crosslinked polyphenylsulfone, and wherein the downhole assembly is disposed when the shape-memory article is in a compacted shape; and contacting the shape-memory article in the compacted shape with a fluid to cause the shape-memory article to expand, and conform to a surface of the wellbore.

All ranges disclosed herein are inclusive of the endpoints, and the endpoints are independently combinable with each other (e.g., a range of “5 wt % to 20 wt %” is inclusive of the endpoints and all intermediate values of the ranges of “5 wt % to 25 wt %,” etc.). “Combinations” is inclusive of blends, mixtures, alloys, reaction products, and the like. “Or” means “and/or” unless clearly stated otherwise. The use of the terms “a” and “an” and “the” and similar referents in the context of describing the invention (especially in the context of the following claims) are to be construed to cover both the singular and the plural, unless otherwise indicated herein or clearly contradicted by context. The term “about” is intended to include the degree of error associated with measurement of the particular quantity based upon the equipment available at the time of filing the application. For example, “about” can include a range of +8% of a given value.

Unless defined otherwise, technical and scientific terms used herein have the same meaning as is commonly understood by one of skill in the art to which this invention belongs.

While typical methods/downhole assemblies have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A method of manufacturing a shape-memory article, the method comprising:
combining a polymer with a particulate water soluble salt to form a mixture;
molding the mixture to form a molded article;
heating the molded article in the presence of oxygen, forming a sintered article comprising a crosslinked polymer;
exposing the sintered article to water to remove the particulate water soluble salt from the sintered article, forming the shape-memory article, which is a porous foam comprising the crosslinked polymer.

2. The method of claim 1, wherein the polymer has a glass transition temperature of about 120° C. to about 200° C.

3. The method of claim 1, wherein the polymer is at least one of a polyetheretherketon, a polyetherketoneketone, a polyphenylene sulfide, or a polyphenylsulfone.

4. The method of claim 1, wherein the polymer is in a particulate form.

5. The method of claim 1, wherein the polymer and the particulate water soluble salt have a weight ratio of about 10:90 to about 90:10.

6. The method of claim 1, wherein the particulate water soluble salt has a particle size of about 0.062 millimeter to about 1 millimeter.

7. The method of claim 1, wherein the particulate water soluble salt has a melting point of greater than 300° C. and a solubility in water of greater than 25 grams per 100 grams of water at 25° C.

8. The method of claim 1, wherein the particulate water soluble salt comprises at least one of sodium chloride, calcium chloride, or magnesium chloride.

9. The method of claim 1, wherein the mixture is free of blowing agents, crosslinking agents, curing agents, or a combination thereof.

10. The method of claim 1, wherein the mixture is molded under a pressure of about 1000 psi to about 1900 psi to form the molded article.

11. The method of claim 1, wherein the mixture is molded at a temperature of about 15° C. to about 30° C.

12. The method of claim 1, wherein the molded article is heated at a temperature which is greater than a melting point of the polymer but less than a melting point of the particulate water soluble salt in the presence of oxygen to crosslink the polymer, forming the sintered article.

13. The method of claim 1, wherein the molded article is heated under atmospheric pressure to crosslink the polymer.

14. The method of claim 1, wherein the molded article is heated at a temperature of about 300° C. to about 800° C. under atmospheric pressure to crosslink the polymer, forming the sintered article.

15. The method of claim 1, wherein the sintered article is exposed to water having a temperature of about 60° C. to about 100° C. to remove the particulate water soluble salt from the molded article.

16. The method of claim 1, wherein the crosslinked polymer is amorphous.

17. The method of claim 1, comprising:
combining the polymer with the particulate water soluble salt to form the mixture,
the polymer comprising at least one of polyetheretherketon, a polyetherketoneketone, a polyphenylene sulfide, or a polyphenylsulfone,
the particulate water soluble salt has a melting point of greater than 300° C. and a solubility in water of greater than 25 grams per 100 grams of water at 25° C.;
molding the mixture at a temperature of about 15° C. to about 30° C. and a pressure of about 1000 psi to about 1900 psi to form the molded article;
heating the molded article at a temperature that is greater than a melting point of the polymer but lower than a melting point of the particulate water soluble salt under atmospheric pressure in the presence of oxygen, forming the sintered article; and
exposing the sintered article to water at a temperature of about 60° C. to about 100° C. to remove the particulate water soluble salt from the sintered article, forming the shape-memory article.

18. A downhole assembly comprising:
a support structure;
a shape-memory article disposed at the support structure; and
the shape-memory article comprising a porous foam, the porous foam comprising at least one of an amorphous crosslinked polyetheretherketon, an amorphous crosslinked polyetherketoneketone, an amorphous crosslinked polyphenylene sulfide, or an amorphous crosslinked polyphenylsulfone.

19. The downhole assembly of claim 18, wherein the porous foam is free of blowing agents.

20. The downhole assembly of claim 18, wherein the porous foam comprises the amorphous crosslinked polyetheretherketon.

21. The downhole assembly of claim 20, wherein the amorphous crosslinked polyetheretherketon comprises polyetheretherketon crosslinked by oxygen.

22. The downhole assembly of claim 18, wherein the porous foam has a density of about 0.19 g/cm³ to about 0.37 g/cm³.

23. A method comprising:
introducing into a wellbore a downhole assembly comprising
a support structure;
a shape-memory article disposed at the support structure and comprising a
porous foam, which comprises at least one of an amorphous crosslinked polyetheretherketon, an amorphous crosslinked polyetherketoneketone, an amorphous crosslinked polyphenylene sulfide, or an amorphous crosslinked polyphenylsulfone, and
wherein the downhole assembly is disposed when the shape-memory article is in a compacted shape; and
contacting the shape-memory article in the compacted shape with a fluid to cause the shape-memory article to expand, and conform to a surface of the wellbore.
